(19) United States
(12) Patent Application Publication
(10) Pub. No.: US 2025/0099962 A1
(43) Pub. Date: Mar. 27, 2025

(54) Protected Blood Collection Tube

(71) Applicant: Biomedical Regenerative GF, LLC, Boca Raton, FL (US)

(72) Inventor: Claudia Santamaria, Boca Raton, FL (US)

(21) Appl. No.: 18/973,074

(22) Filed: Dec. 8, 2024

Related U.S. Application Data
(63) Continuation-in-part of application No. 16/607,641, filed on Oct. 23, 2019.
(60) Provisional application No. 62/503,219, filed on May 8, 2017.

(51) Int. Cl. B01L 3/00

(52) U.S. Cl. CPC B01L 3/5082; B01L 2200/0689; B01L 2300/044; B01L 2300/0832; B01L 2300/0887

(57) ABSTRACT

A protected blood collection tube. The protected blood collection tube and sample includes a breakable inner container and an outer protective body. The inner container can receive a sample for applications such as biomedical, health care, dentistry, agricultural, industrial, and veterinary. The inner container can be received into the outer protective body for protection. A lid secures over the inner container forming a seal to prevent leakage and contamination of the sample or inner container contents. The outer protective body is breakage-resistant for protection if the protected blood collection tube is dropped.

### CROSS REFERENCE TO RELATED APPLICATION

This application is a continuation-in-part of U.S. national stage application number 16,607,641 having a filing date of Oct. 23, 2019, from international application number PCT/US2018/031704, having an international filing date of May 8, 2018, and which claims priority to U.S. provisional application No. 62/503,219 having a filing date of May 8, 2017. The entire contents of the foregoing—all entitled Protected blood collection tube—are incorporated by reference.

### FIELD OF THE DISCLOSURE

The present disclosure relates to health care equipment and devices for protecting inner containers. More specifically, the present disclosure relates to devices for protecting containers capable of holding fluid, clot, and tissue specimens for storage, analysis, or processing in medical, pharmaceutical, clinical, forensic, dental, industrial, agricultural, environmental, and veterinary applications.

### BACKGROUND OF THE DISCLOSURE

In the biomedical science and health care industries in particular, blood is drawn for various tests to assess an animal's health. Test tubes for storing, transporting, and processing blood may have an additive for either promoting or inhibiting clotting, depending on the intended application. From the blood sample, the intended application may require the testing or processing of serum or plasma. To accomplish this, the blood is disposed of in a test tube with an additive or coating.

Modern blood collection tubes and test tubes are made from polyethylene terephthalate (PET) medical-grade plastic, requiring treatment with additives or coatings, especially in applications requiring centrifugation to obtain a serum or plasma clot. Plastic is almost exclusively used due to the risks that glass test and blood collection tubes pose: breakage, contamination of the sample, contamination of the laboratory, contamination and injury of the personnel handling the sample, and the spread of blood-borne pathogens and diseases. The test and blood collection tube materials, coatings, additives, and specifications are therefore regulated by governing agencies such as the U.S. Food and Drug Administration, National Institute for Occupational Safety and Health, Centers for Disease Control and Prevention, and the Occupational Safety and Health Administration which generally require test and blood collection tubes that are not made of glass unless otherwise adequately protected.

Traditionally, blood collection tubes were made of glass, particularly in the mid 1900's. Glass tubes did not require a clotting additive or coating because the silica in the natural glass surface already promoted clotting. The blood would coagulate and during centrifugation would fall to the bottom of the tube, leaving a plasma clot and a supernatant of serum at the upper portion of the tube.

Glass test tubes and blood collection tubes are ideal for biomedical and health care applications requiring the retrieval of plasma or serum clots. Newer regenerative treatments with platelet-rich plasma and platelet-rich fibrin for example require drawing a person's blood, spinning the sample down in a centrifuge, retrieving plasma in platelet-rich plasma or retrieving clotted plasma in platelet-rich fibrin, and treating the person with the supernatant that may or may not be further processed. These applications are distinguished from drawing blood merely for in vitro health screenings because part of the sample (the supernatant containing plasma or serum that is platelet rich) is returned to the person's body.

In a particular example, platelet-rich fibrin applications in dental procedures is becoming increasingly popular due to expedited healing. Other applications include hair loss, wrinkle and antiaging, and orthopedic treatments. These treatments typically require multiple sessions. Multiple sessions also means greater exposure to additives from plastic tubes.

Plastic test tubes are generally treated with silicones and silicas. Inhalation and internal exposure to silicas can result in fibroids and subsequently cancer. Exposure to the additives likely poses an industrial occupational hazard for those in the manufacturing sector. People receiving treatments with their own serum or plasma are exposed to additive residue, sometimes directly into the bloodstream if the serum or plasma is injected or topically applied to an open wound or suture.

Accordingly, sample exposure to additives or coatings as inherently occurring with plastic tubes should be avoided or eliminated while still conforming to government regulations. In addition, simply placing one tube inside another tube is unsatisfactory for use in procedures where a centrifuge is necessary due to the instability of the inner tube during centrifugation. Tubes with outer screw caps and support spacer structures are also not compatible for use with blood, tissue, plasma, serum, or clot processing in procedures involving platelet-rich fibrin and platelet-rich plasma due to instability in a centrifuge and increased complexity in handling, leading to increase risk of contamination or breakage.

### SUMMARY OF THE DISCLOSURE

What is needed is a cost-effective protected blood collection tube having a breakable inner container and an inner container housed in the cavity of an outer protective body with a single lid that fits over and holds in place both the inner container and the outer container. The outer container is fixably or removably attached to the inner container.

The inner container can hold a sample such as bodily fluid like as blood, serum, plasma, and clots. The inner container is configured to fit inside an internal cavity defined by the outer protective body.

A lid prevents contamination or expulsion of a sample disposed within the inner container. The lid is configured to be securable upon the upper end of the outer protective body while providing a vacuum seal as well as positional stabilization for the inner container. The lid is configured to be frictionally secured over the upper end of the outer protective body. Frictional security provides enhanced stability and contamination prevention for the protected blood collection tube. The outer protective body has a ledge disposed at an upper end thereof. The ledge is configured to securely receive the lid thereon.

### BRIEF DESCRIPTION OF THE DRAWINGS

The accompanying drawings, that are incorporated in and constitute a part of this specification, illustrate several embodiments of the disclosure and, together with the description, they serve to explain the principles of the disclosure.

FIG. 1 shows an exploded view of an exemplary protected blood collection tube.

FIG. 2 shows a perspective view of the exemplary protected blood collection tube of FIG. 1.

FIG. 3 shows a side-sectional view of an exemplary protected blood collection tube.

FIG. 4 shows an additional side sectional view of the exemplary protected blood collection tube of FIG. 3.

FIG. 5 shows an enlarged side sectional view of an open end of the exemplary protected blood collection tube of FIGS. 3 and 4.

FIG. 6 shows a perspective view of an exemplary protected blood collection tube in a sterile pack.

FIG. 7 shows a side-sectional view of an exemplary protected blood collection tube.

FIG. 8 shows an exploded view of an exemplary protected blood collection tube with a strap.

### REFERENCE NUMERALS OF THE DRAWINGS

10 device
11 inner container
12 outer protective body
13 housing
14 internal cavity
15 open end
16 rim
17 elongated tubular housing
18 open upper end
19 lip
20 ledge
21 wall
22 lid
23 base
24 receptacle
25 cap
26 first seal
27 second seal
28 strap
29 ridge
30 connection point
32 fastener
33 sterilized housing
34 void
40 strap
41 fastener
42 closed end

### DETAILED DESCRIPTION

The present disclosure provides generally for a protected blood collection tube device, especially for use in industries such as biomedical science, health care, dentistry, agriculture, industrial, and veterinary health and wellness.

According to the present disclosure, the device generally comprises an inner container housed in the cavity of an outer protective body. The outer protective body may be fixably or removably attached to the inner container. The inner container is capable of holding a a sample of blood, plasma, serum, or clots.

In preferred embodiments, the inner container is made of a glass such as borosilicate for example, and the outer protective body is made out of a molded or extruded plastic such as PET. In preferred embodiments, the outer protective body is translucent or transparent to allow visibility of the sample in the inner container. The glass inner container provides compatibility with the sample for storage and processing while the plastic outer protective body prevents breakage of the inner container and destruction and contamination of the sample.

In preferred embodiments, the outer protective body may be removed and autoclaved for interchangeable or recycled use. However, in some embodiments, the outer protective body may be fixably attached to an inner container for single use. The protective body is preferably configured to fit in standard centrifuges and test tube holders.

In preferred embodiments and under sterile conditions, a lid and/or a cap applied will create a vacuum seal yet provide penetration of a needle into the inner container to retrieve a sample. The sample may then be further processed, applied to or within an animal's body, or used for in vitro experimentation.

Specialized sterile packs may be customized according to the intended application. For example, dental and oral surgery procedures using platelet-rich fibrin may require one to six devices in a sterile pack for single use whereas environmental applications may require a pack of twelve tubes for various sample sites.

Preferably, the device should be treated like any other collection or test tube with safety precautions such as placing the device in a holder when not in use or when placing an inner container, cap, lid, or strap on or into the device's outer container.

A sample may comprise a solid, liquid, or gas. A sample may be deposited into the inner container before or after the inner container is inserted into the outer container or protective body if the outer protective body is removably attached.

The protected blood collection tube is especially useful for platelet-rich fibrin and platelet-rich plasma procedures where the tube is handled multiple times and used in a centrifuge since the exemplary structures provide for stable centrifugation and reduced risk of breakage or contamination.

In the following sections, detailed descriptions of examples and methods of the disclosure will be given. The description of both preferred and alternative examples are exemplary only, and it is understood that to those skilled in the art that variations, modifications, and alterations may be apparent. It is therefore to be understood that the examples do not limit the broadness of the aspects of the underlying disclosure as defined by the claims.

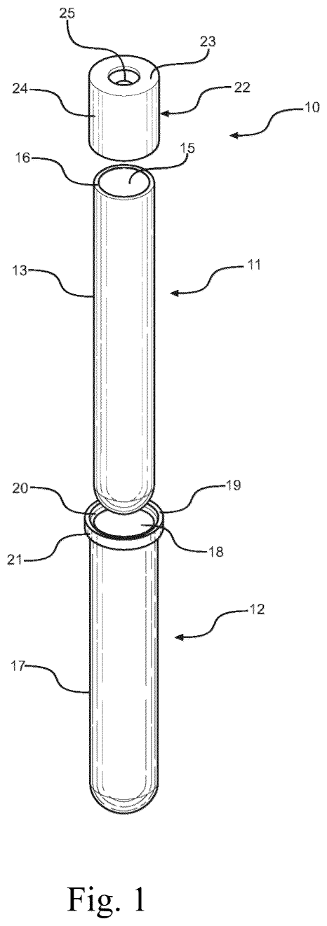

Referring to FIG. 1, an exploded view of an exemplary protected blood collection tube is shown. The protected blood collection tube 10 (“the device”) comprises an inner container 11 and an outer protective body 12. In the shown embodiment, the inner container 11 comprises an elongated tubular housing 13 defining an internal cavity 14 therein with an open end 15 disposed oppositely a closed lower end. The lower end is of any suitable shape. Additionally, in the illustrated embodiment, the closed lower end is rounded. The open upper end 15 is defined by a rim 16.

Furthermore, the inner container 11 is configured to receive a biological, medical, fluids, food or chemical sample therein. The inner container 11 is made of a non-contaminating material. In one embodiment, the inner container 11 is made of glass. When using glass, blood coagulation is promoted in the cavity 14 wherein the biological, medical or chemical sample is a blood sample.

In another embodiment, the inner container 11 further comprises at least one additive, such as an SFS coating, a gel, a clot activator, a separator or an anticoagulant compound. In another embodiment, the inner container 11 is vacuum-sealed by a cap 25 which may secure a lid 22 or be independent therefrom depending on the type of inner container used such as a standard tube or a vacuum sealed tube. The inner container 11 may be any container configured to receive a sample therein.

In one embodiment, the inner container is configured to be processed in a centrifuge when assembled with the outer protective body 12. In another embodiment, the inner container is configured to be used in the manufacture of platelet rich fibrin (PRF). In yet another embodiment, the inner container is configured to be used in In Vitro Diagnostic (IVD) tests. In another embodiment, the outer protective body 12 comprises an elongated tubular housing 17 defining a cavity therein with an open upper end 18. The open upper end 18 is defined by a lip 19.

The outer protective body 12 is configured to house the inner container 11 therein. The outer protective body 12 is configured to prevent breakage of the inner container 11. The outer protective body 12 is made of a shatter-resistant material, such as medical-grade PET, plastic, latex, ceramic, fiberglass, metal, flexi-glass, rubber, melamine, tempered glass, polypropylene, carton, glazed stoneware, metallic glass, or a combination of the above materials. The outer protective body 12 is further configured to be shock-resistant, meaning that the outer protective body 12 can sustain an impact without damage to an internal component, such as the inner container 11 or the fluid or sample such as blood, plasma, serum, or clot disposed therein.

The outer protective body defines the internal cavity with an open end. The outer protective body comprises an open upper end having a lip, a ledge oriented on a horizontal axis, and a wall oriented on a vertical axis and which receives a lid capable of being punctured with a needle. The inner container includes an interior volume that is vacuum sealed by the lid which cooperatively engages with the outer protective body to concentrically form a first seal between the inner container and an internal side of a base of the lid and to concentrically form a second seal between the outer protective body and the lid at the lip of the outer protective body. The walls of the inner container do not contact the walls of the outer container.

In one embodiment, the inner container 11 is longer in length, from the rim to the bottom, than the outer protective body 12, such that a portion of the inner container 11 extends above the lip 19 of the outer protective body 12. The lip 19 defines a ledge 20 with a wall 21 extending upward therefrom. When the device for protecting a sample 10 is placed in a vertical position, the ledge 20 is oriented on a horizontal axis and the wall 21 is oriented on a vertical axis. The outer protective body 12 is sized to receive the inner container 11 in the cavity thereof.

For example, the outer protective body may be 15 centimeters long and the inner container may be 10 or 12 centimeters long. In another example, the outer protective body and the inner container may be the same length. Conventional sizes and shapes may be implemented.

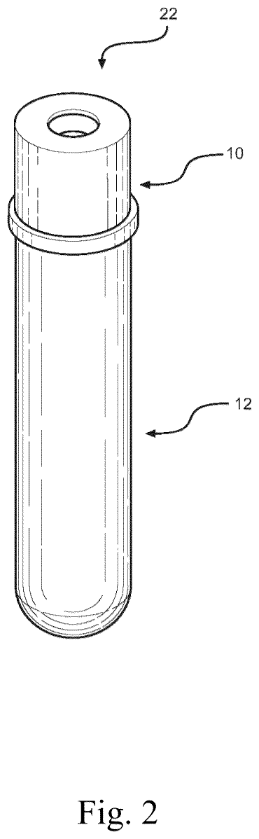

Referring to FIG. 2, a perspective view of an exemplary protected blood collection tube of FIG. 1 is shown. The protected blood collection tube 10 is configured to be arranged in a containment position and an open position. The containment position is defined where the inner container is removably disposed within the outer protective body 12. Furthermore, in the containment position, the lid 22 is engaged upon the outer protective body 12, such as to ensure that the fluid or sample such as blood, plasma, serum, or clot disposed therein will not leak in the unlikely yet possible event the inner container breaks during handling or centrifugation.

The outer protective body defines the internal cavity with an open end. The outer protective body comprises an open upper end having a lip, a ledge oriented on a horizontal axis, and a wall oriented on a vertical axis and which receives a lid capable of being punctured with a needle. The inner container includes an interior volume that is vacuum sealed by the lid which cooperatively engages with the outer protective body to concentrically form a first seal between the inner container and an internal side of a base of the lid and to concentrically form a second seal between the outer protective body and the lid at the lip of the outer protective body. The walls of the inner container do not contact the walls of the outer container.

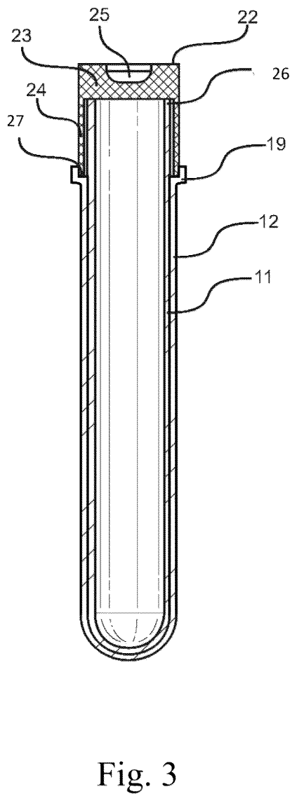

Referring to FIG. 3, a side sectional view of an exemplary protected blood collection tube is shown. The outer protective body 12 comprises an interface configured to receive a cap 25. Under the shown embodiment, the cap 25, or alternatively a lid 22 depending on configuration, may attach to the outer protective body 12 and aligns with the lip 19 disposed on an upper portion of the outer protective body 12. The lid cooperatively engages and forms a seal with both the outer protective body and the inner protective body in a concentric arrangement. The inner container is solid and impenetrable, and the inner container retains and isolates fluid therein and prevents escape of the fluid from the inner container to the outer container. This embodiment ensures that fluid will not escape from the cavity of the inner container 11 as a first seal 26 is formed between the inner container 11 and an internal side of the base 23 of the lid 25. Additionally, a second seal 27 is formed between the outer protective body 12 and the cap 25 or lid 22 at the lip 19. The walls of the inner container do not contact inner walls of the outer container while a single lid concentrically engages both the inner container and the outer container, and no spacing structure or protrusion on either the inner container or the outer container is required. Therefore, exemplary protected blood collection tubes are stable in a centrifuge.

In the illustrated embodiment, the lid 22 is vertically lower than the periphery of the cap 25 disposed around the lid 22. Under this embodiment, the indent is easier to locate and is easier to penetrate with a needle. Alternatively and depending on the configuration of the inner container, the cap 25 may be vertically lower than the lid 22. Clearances may be by 0.2 mm to 2 cm for example.

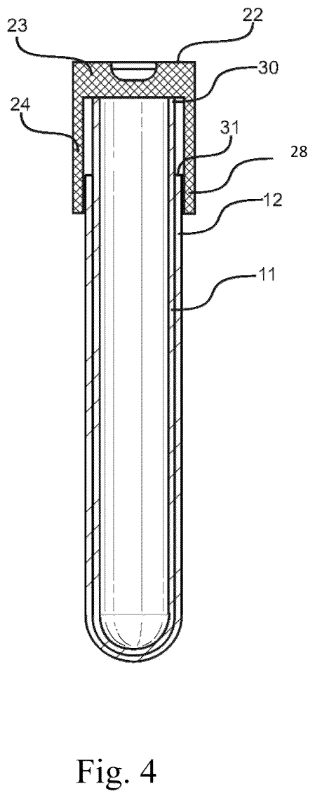

Referring to FIG. 4, an additional side sectional view of the exemplary protected blood collection tube of FIG. 3 is shown. Under the shown embodiment, the lid is frictionally secured to the device for protecting a sample. A first seal 26 is frictionally formed between the inner container 11 and the base 23 of the lid 22. Additionally, a second seal 27 is frictionally formed between the outer protective body 12 and an overlapping portion 40 of the receptacle 24 of the lid 22. In other words, the lid cooperatively engages and forms a seal with both the outer protective body and the inner protective body in a concentric arrangement while the walls of the inner container do not contact inner walls of the outer container, and no spacing structure or protrusion on either the inner container or the outer container is required. The inner container is solid and impenetrable, and the inner container retains and isolates a fluid therein and prevents escape of the fluid from the inner container to the outer container Therefore, exemplary protected blood collection tubes are stable in a centrifuge.

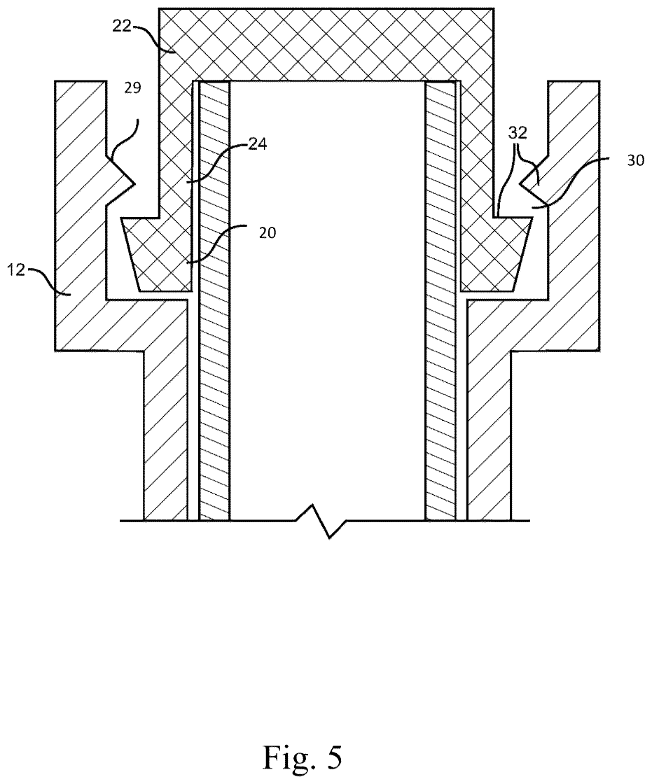

Referring to FIG. 5, an enlarged side sectional view of an open end of the exemplary protected blood collection tube of FIGS. 3 and 4 is shown. In one embodiment, the device for protecting a sample comprises a fastener 32 disposed between the connection point 30 of the lid 22 and the outer protective body 12. The inner container includes an interior volume that is vacuum sealed by the lid which cooperatively engages with the outer protective body to concentrically form a first seal between the inner container and an internal side of a base of the lid, and to concentrically form a second seal between the outer protective body and the lid at the lip of the outer protective body wherein the lip defines the ledge with a wall extending upward from the ledge. The walls of the inner container do not contact the inner walls of the outer container, and no spacing structure or protrusion on either the inner container or the outer container is required. The inner container is solid and impenetrable, and the inner container retains and isolates a fluid therein and prevents escape of the fluid from the inner container to the outer container. Therefore, exemplary protected blood collection tubes are stable in a centrifuge.

In the illustrated embodiment, the fastener comprises a ridge 29 and a ledge 20. The ridge 29 is disposed on the internal surface of the outer protective body 12. The ledge 20 is disposed on the external surface of the receptacle 24. When the device for protecting a sample is placed into a locked position, the ledge 20 will pass under the ridge 29, such that the lid will be frictionally secured to the outer protective body 12. The lid cooperatively engages and forms a seal with both the outer protective body and the inner protective body in a concentric arrangement.

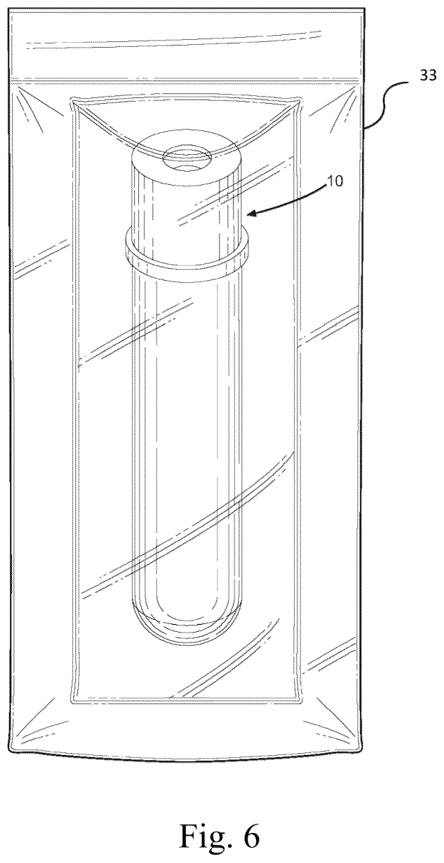

Referring to FIG. 6, a perspective view of an exemplary protected blood collection tube in a sterile pack is shown. In one embodiment, the sterilized housing 33 is configured to receive the inner container, the outer protective body and the lid therein. By packaging the device for protecting a sample 10 in the sterilized housing 33, it is ensured that the device for protecting a sample will be sterile when used. In the illustrated embodiment, the sterilized housing 33 is transparent. The sterilized housing 33 is made of any suitable material, such as plastic.

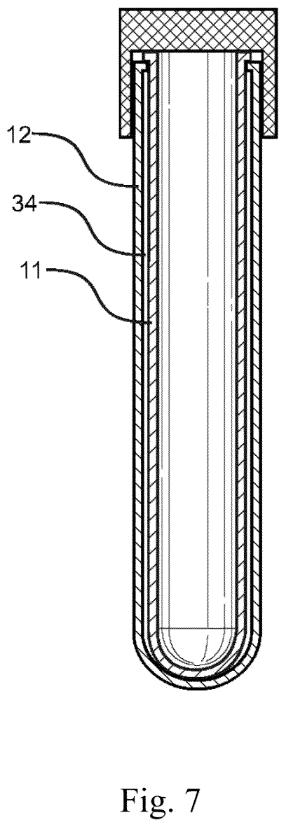

Referring to FIG. 7, a side sectional view of an alternative exemplary protected blood collection tube is shown. This particular embodiment contains In one embodiment, a void 34 is defined between the inner container 11 and the outer protective body 12. The void 34 may be of any desired size. In one embodiment, the space 34 extends entirely between the inner container 11 and the outer protective body 12. In another embodiment, the void 34 is at least partially filled with a solid, a liquid or a gas.

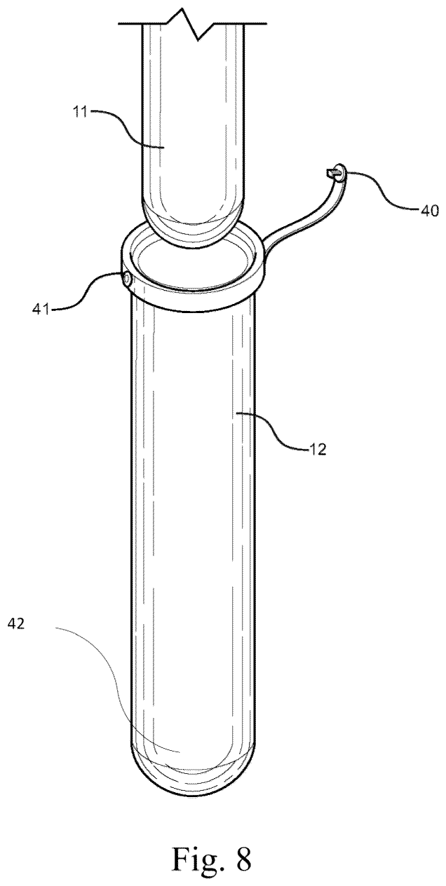

Referring to FIG. 8, an exploded view of an exemplary protected blood collection tube with a strap is shown. Under the shown embodiment, the outer protective body 12 comprises a strap 40 disposed on an end thereof, preferably opposite a closed end 42. The strap 40 is configured to interact with a fastener 41, such that the inner container 11 can be secured in the outer protective body 12 by the strap. This configuration allows for a greater variety of inner containers to be used with the device. The device's outer body may be made from a material selected from the group consisting of polyethylene terephthalate, plastic, latex, ceramic, fiberglass, metal and any breakage-resistant material.

The device may be used with inner containers made from glass, ceramic, porcelain, plastics and may also have additives such as a coating, a gel, a clot activator, a surfactant, a separator, or an anticoagulant compound.

A number of embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Thus, particular embodiments of the subject matter have been described. Other embodiments are within the scope of the following claims. In some cases, the actions recited in the claims can be performed in a different order and still achieve desirable results. Nevertheless, it will be understood that various modifications may be made without departing from the spirit and scope of the claimed disclosure.

What is claimed is:

1. A protected blood collection tube made of glass and suitable for use in a centrifuge, the protected blood collection tube comprising:
an outer protective body made of a plastic material which encompasses an inner container made of a glass material that is disposed in an internal cavity of the outer protective body;
wherein the outer protective body defines the internal cavity with an open end;
wherein the outer protective body is configured to prevent breakage of the inner container;
wherein the outer protective body comprises an open upper end having a lip, a ledge oriented on a horizontal axis, and a wall oriented on a vertical axis and which receives a lid capable of being punctured with a needle;
wherein the inner container includes an interior volume that is vacuum sealed by the lid which cooperatively engages with the outer protective body to concentrically form a first seal between the inner container and an internal side of a base of the lid, and to concentrically form a second seal between the outer protective body and the lid at the lip of the outer protective body wherein the lip defines the ledge with a wall extending upward from the ledge; and
wherein the inner container is solid and impenetrable, and the inner container retains and isolates a fluid therein and prevents escape of the fluid from the inner container to the outer container; and
wherein walls of the inner container do not contact the walls of the outer container.
